(19) United States
(12) Patent Application Publication
(10) Pub. No.: US 2024/0399250 A1
(43) Pub. Date: Dec. 5, 2024

(54) VIRTUAL OBJECT CONTROL

(71) Applicant: Tencent Technology (Shenzhen) Company Limited, Shenzhen (CN)

(72) Inventor: Jiazhi Jiang, Shenzhen (CN)

(21) Appl. No.: 18/798,568

(22) Filed: Aug. 8, 2024

Related U.S. Application Data
(63) Continuation of application No. PCT/CN2023/130204, filed on Nov. 7, 2023.

(30) Foreign Application Priority Data
Dec. 15, 2022 (CN) 202211616547.5

(51) Int. Cl. A63F 13/533; A63F 13/2145; A63F 13/5258; A63F 13/55

(52) U.S. Cl. CPC A63F 13/533; A63F 13/5258; A63F 13/55; A63F 13/2145

(57) ABSTRACT

The application describes a virtual object control method and apparatus, a terminal, and a storage medium. The method includes: displaying, on a virtual scene interface, a first virtual object, a first virtual wheel, and a second virtual wheel corresponding to a target skill; selecting, in response to a first operation on the second virtual wheel, a skill effect-taking location based on a movement direction of the first operation, and controlling the first virtual object to release the target skill to the selected skill effect-taking location at an end of the first operation; and adjusting, in response to a second operation on the first virtual wheel, the skill effect-taking location of the target skill based on a movement direction of the second operation within the effect-taking duration of the target skill, and controlling the first virtual object to follow an adjusted skill effect-taking location to release the target skill.

### RELATED APPLICATIONS

This application is a continuation application of PCT Application PCT/CN2023/130204, filed Nov. 7, 2023, which claims priority to Chinese Patent Application No. 202211616547.5 filed on Dec. 15, 2022, each entitled “VIRTUAL OBJECT CONTROL METHOD AND APPARATUS, TERMINAL, AND STORAGE MEDIUM”, and each of which is incorporated herein by reference in its entirety.

### FIELD OF THE TECHNOLOGY

This application is related to the field of computer technologies, and in particular, to a virtual object control method and apparatus, a terminal, and a storage medium.

### BACKGROUND OF THE DISCLOSURE

With rapid development of a computer technology and popularity of a smart terminal, video games have become popular. In a virtual scene provided by an electronic game (e.g., video game), a user may control a virtual object to release a skill to another virtual object, for example, to release an offensive skill to an enemy virtual object, or to release an auxiliary skill to a friend virtual object.

In related art, the user controls the virtual object to release the skill to an aimed location. However, if the aimed location deviates, the skill is caused to be wasted. If the aimed location is wanted to be adjusted, the virtual object needs to be re-controlled to release the skill.

### SUMMARY

This application provides a virtual object control method and apparatus, a terminal, and a storage medium, to improve human-computer interaction efficiency of controlling a virtual object. Technical solutions are as follows.

According to one aspect, a virtual object control method is provided, performed by a computing device (e.g., terminal), the method including:
displaying, on a virtual scene interface, a first virtual object, a first virtual wheel, and a second virtual wheel corresponding to a target skill, the first virtual wheel being configured to control a movement direction of the first virtual object;
selecting, in response to a first operation (e.g., a first movement operation) on the second virtual wheel, a skill effect-taking location based on a movement direction of the first operation, and controlling the first virtual object to release the target skill to the currently selected skill effect-taking location at an end of the first operation, the target skill having effect-taking duration; and
adjusting, in response to a second operation (e.g., a second movement operation) on the first virtual wheel, the skill effect-taking location of the target skill based on a movement direction of the second operation within the effect-taking duration of the target skill, and controlling the first virtual object to follow an adjusted skill effect-taking location to release the target skill.

According to another aspect, a virtual object control apparatus is provided, including one or more processors and memory storing instructions, when executed by the one or more processors, cause the apparatus to perform the methods described herein. The virtual object control apparatus may include:
a display module, configured to display, on a virtual scene interface, a first virtual object, a first virtual wheel, and a second virtual wheel corresponding to a target skill, the first virtual wheel being configured to control a movement direction of the first virtual object in a case that the first virtual object does not release any skill;
a skill release module, configured to select, in response to a first movement operation on the second virtual wheel, a skill effect-taking location based on a movement direction of the first movement operation, and control the first virtual object to release the target skill to the currently selected skill effect-taking location at an end of the first movement operation, the target skill having effect-taking duration; and
a location adjusting module, configured to adjust, in response to a second movement operation on the first virtual wheel, the skill effect-taking location of the target skill based on a movement direction of the second movement operation within the effect-taking duration of the target skill, and control the first virtual object to follow an adjusted skill effect-taking location to release the target skill.

According to another aspect, a terminal is provided, including a processor and a memory, the memory having at least one computer program stored therein, the at least one computer program being loaded and executed by the processor to enable the terminal to implement operations performed according to the virtual object control method according to the foregoing aspects.

According to another aspect, a non-transitory (e.g., non-volatile) computer-readable storage medium is provided, having at least one computer program stored thereon, the at least one computer program being loaded and executed by a processor to enable a computer to implement operations performed according to the virtual object control method according to the foregoing aspects.

According to another aspect, a computer program product is provided, including a computer program, the computer program being loaded and executed by a processor to enable a computer to implement operations performed according to the virtual object control method according to the foregoing aspects.

According to the method, apparatus, terminal, and storage medium provided in examples of this application, a player may control a second virtual wheel to select an initial skill effect-taking location and release a skill at the effect-taking location. Within effect-taking duration of the skill, the player may further control a first virtual wheel to continue to adjust the skill effect-taking location, and does not need to perform an operation of releasing the skill again. In addition, because the first virtual wheel is originally used to control a movement direction of a virtual object, the player is familiar with the first virtual wheel. During a skill effect-taking period, the first virtual wheel is used to adjust the effect-taking location, to enable the operation of the player to be smooth, reduce operating burden of the player, and improve convenience of adjusting the skill effect-taking location, thereby improving human-computer interaction efficiency of controlling a virtual object.

### BRIEF DESCRIPTION OF THE DRAWINGS

FIG. 1 is a schematic diagram of an implementation environment according to an example of this application.

FIG. 2 is a flowchart of a virtual object control method according to an example of this application.

FIG. 3 is a flowchart of a virtual object control method according to an example of this application.

FIG. 4 is a schematic diagram of a virtual scene interface according to an example of this application.

FIG. 5 is a schematic diagram of another virtual scene interface according to an example of this application.

FIG. 6 is a schematic diagram of another virtual scene interface according to an example of this application.

FIG. 7 is a schematic diagram of another virtual scene interface according to an example of this application.

FIG. 8 is a flowchart of a virtual object control method according to an example of this application.

FIG. 9 is a schematic diagram of a structure of a virtual object control apparatus according to an example of this application.

FIG. 10 is a schematic diagram of a structure of a terminal according to an example of this application.

### DESCRIPTION OF EMBODIMENTS

To make objectives, technical solutions, and advantages of examples of this application clearer, the following further describes in detail implementations of this application with reference to the accompanying drawings.

The terms “first”, “second”, and the like used in this application may be used for describing various concepts in this specification. However, the concepts are not limited by the terms unless otherwise specified. The terms are merely used for distinguishing one concept from another concept. For example, without departing from the scope of this application, a first virtual object may be referred to as a second virtual object, and similarly, the second virtual object may be referred to as the first virtual object.

The term “at least one” indicates one or more than one. For example, at least one virtual object may be one virtual object, two virtual objects, three virtual objects, or any integer number of virtual objects greater than or equal to one. The term “a plurality of” indicates two or more than two. For example, a plurality of virtual objects indicate two virtual objects, three virtual objects, or any integer number of virtual objects greater than or equal to two. The term “each” indicates each of at least one. For example, each virtual object indicates each of a plurality of virtual objects. If the plurality of virtual objects are three virtual objects, each virtual object indicates each of the three virtual objects.

In implementations of this application, related data such as user information is involved. In a case that the foregoing examples of this application are applied to a specific product or technology, a permission or consent of a user is required, and collection, use, and processing of the relevant data need to comply with relevant laws, regulations, and standards of relevant countries and regions.

In related art, the user controls a virtual object to release a skill to an aimed location. However, if the aimed location deviates, the skill is caused to be wasted. If the aimed location is wanted to be adjusted, the virtual object needs to be re-controlled to release the skill. The solution of the related art is cumbersome to operate, resulting in low human-computer interaction efficiency of controlling a virtual object. Therefore, a virtual object control method that can improve the human-computer interaction efficiency of controlling a virtual object needs to be provided.

A virtual scene related to this application may be configured to simulate a virtual space (e.g., a three-dimensional virtual space). The three-dimensional virtual space may be an open space. The virtual scene may be configured to simulate a real environment in reality. For example, the virtual scene may include the sky, the land, the ocean, and the like. The land can include an environmental element such as a desert and a city. The virtual scene may further include a virtual item, such as a virtual throwing object, a virtual building, a virtual vehicle, and a term needed by virtual objects in the virtual scene to arm themselves or fight with another virtual object. The virtual scene may further be configured to simulate real environments under different weather conditions, such as sunny, rainy, foggy, or snowy. Various scene elements enhance diversity and authenticity of the virtual scene.

The user controls a virtual object to move in the virtual scene. The virtual object is a virtual image in the virtual scene configured to represent the user. The virtual image may be in any form, such as a person or an animal, which is not limited in this application. Using an electronic game as an example, the electronic game may be a first-person shooting game, a third-person shooting game, or another electronic game in which a term is used for a long-range attack. Using a shooting game as an example, in the virtual scene, the user may control the virtual object to fall freely, glide, open a parachute to fall in the sky, or the like, or to run, jump, creep, bend forward in the land, or the like; or control the virtual object to swim, float, dive in the ocean, or the like. The user may further control the virtual object to ride in a vehicle to move in the virtual scene. The user may further control the virtual object to enter and exit a virtual building in the virtual scene, discover and pick up a virtual item (such as a virtual throwing object or a term) in the virtual scene to fight with another virtual object by using the picked up virtual item. For example, the virtual item may be virtual clothing, a virtual helmet, or a virtual medical supply, or may be a virtual item left over after another virtual object is eliminated. The foregoing scene is only used as an example herein and is not specifically limited in examples of this application.

Using an electronic game scene as an example in examples of this application, the user operates on a terminal in advance. After detecting an operation of the user, the terminal downloads a game configuration file of the electronic game. The game configuration file includes an application of the electronic game, interface display data, virtual scene data, or the like, so that the user, when logging into the electronic game on the terminal, calls the game configuration file to render and display an interface of the electronic game. The user performs a touch control on the terminal, and after detecting the touch control, the terminal determines game data corresponding to the touch control and render and display the game data. The game data includes virtual scene data, behavior data of a virtual object in a virtual scene, and the like.

When rendering and displaying the virtual scene, the terminal displays the virtual scene in full screen, when displaying the virtual scene on a current display interface, the terminal displays a global map independently in a first preset area of the current display interface simultaneously, or only when detecting a click/tap operation on a preset button, the terminal displays the global map. The global map is configured to display a thumbnail of the virtual scene, and the thumbnail is configured to describe a geographical feature, such as terrain, landforms, and a geographical location corresponding to the virtual scene. The terminal may further display a thumbnail of a virtual scene within a specific distance around a current virtual object on a current display interface. When detecting a click/tap operation on the global map, the terminal displays an entire virtual scene in a second preset area of the current display interface of the terminal, so that the user can view not only the virtual scene around the current virtual object, but also the entire virtual scene. When detecting a zoom operation on a complete thumbnail, the terminal zooms and displays the complete thumbnail. The complete thumbnail is a thumbnail of the entire virtual scene. In some examples, specific display positions and shapes of the first preset area and the second preset area are set based on an operating habit of the user. For example, to not cause excessive occlusion of the virtual scene, the first preset area is a rectangular area in an upper right corner, a lower right corner, an upper left corner, or a lower left corner of the current display interface. The second preset area is a square area on a right or left side of the current display interface. Alternatively, the first preset area and the second preset area are circular areas or areas of another shape. The specific display positions and shapes of the first preset area and the second preset area are not limited in examples of this application.

FIG. 1 is a schematic diagram of an implementation environment according to an example of this application. As shown in FIG. 1, the implementation environment includes a terminal 101 and a server 102. The terminal 101 and the server 102 may be directly or indirectly connected to each other in a wired or wireless communication manner. An example in which the server 102 is connected to the terminal 101 is only used in FIG. 1. In addition, the server 102 may be connected to another terminal.

In some examples, the terminal 101 is a smartphone, a tablet computer, a notebook computer, a desktop computer, a smart speaker, a smart television, a smartwatch, a handheld portable game device, or the like, but is not limited thereto. The server 102 is an independent physical server, a server cluster or a distributed system including a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), or big data and an artificial intelligence platform.

The server 102 provides a virtual scene for the terminal 101. The terminal 101 can display a virtual scene interface and display a virtual object and the like in the virtual scene interface by using the virtual scene provided by the server 102, and the terminal 101 can control the virtual scene and the virtual object based on the virtual scene interface. The server 102 is configured to perform background processing based on control of the virtual scene by the terminal 101, and provide background support for the terminal 101.

In some examples, the server 102 is a game server. The terminal 101 runs a game application provided by the server 102. The terminal 101 interacts with the server 102 by using the game application.

The virtual object control method provided in this application may be applied to an electronic game scene (e.g., a video game scene).

For example, in a scene in which different virtual objects in the same virtual scene battle, a virtual object in the virtual scene can attack another virtual object by releasing a skill. Using virtual object 1 and virtual object 2 as an example, if virtual object 1 wants to release a target skill to virtual object 2, the method provided in examples of this application is used. First, a player uses a second virtual wheel to aim at a location of virtual object 2 to select an initial skill effect-taking location of a target skill. After the target skill is released to the skill effect-taking location, virtual object 2 moves to avoid the target skill within effect-taking duration of the target skill. In this case, the player may use a first virtual wheel to adjust the skill effect-taking location of the target skill in real time, so that the target skill may hit virtual object 2 all the time within the effect-taking duration.

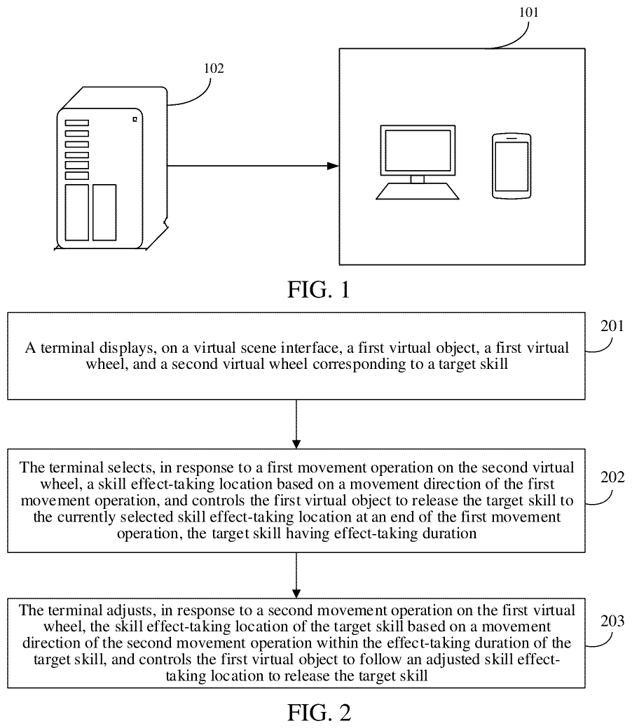

FIG. 2 is a flowchart of a virtual object control method according to an example of this application. This example of this application is performed by a terminal (e.g., a computing device). Refer to FIG. 2. The method includes operation 201 to operation 203.

201: The terminal displays, on a virtual scene interface, a first virtual object, a first virtual wheel, and a second virtual wheel corresponding to a target skill.

The first virtual wheel is configured to control a movement direction of the first virtual object in a case that (e.g., when) the first virtual object does not release any skill.

The virtual scene interface is an interface configured to display a virtual scene. The terminal displays a virtual scene within a view angle range of the first virtual object in the virtual scene interface. The first virtual object is a virtual object controlled by the terminal. The virtual scene further includes another virtual object. This example of this application is applied to a competitive scenario. The competitive scenario is a scenario in which a plurality of virtual objects in the virtual scene activate competitive functions to compete. For example, this example of this application is applied to an electronic game, such as a multiplayer online battle arena game (MOBA). In the MOBA electronic game, in the virtual scene, the plurality of virtual objects may be divided into a plurality of groups. All groups become mutually hostile factions. Each group occupies its own map area and competes with a goal of destroying or occupying some or all of strongholds in a map area corresponding to an enemy.

The first virtual object, the first virtual wheel, and the second virtual wheel corresponding to the target skill are displayed on the virtual scene interface. The first virtual wheel is configured to control the movement direction of the first virtual object in a case that the first virtual object does not release any skill. For example, a press operation is performed on the first virtual wheel, and the first virtual object moves in a movement direction of the press operation. In some examples, the first virtual wheel is displayed on a left side of the virtual scene interface. The first virtual wheel may alternatively be displayed at another location, such as on a right side, of the virtual scene interface.

In some examples, the first virtual wheel may alternatively be a tool dedicated to adjusting an effect-taking location of a released skill.

The skill in examples of this application is a means of interaction between virtual objects. The skill may be divided into an offensive skill and an auxiliary skill. Releasing the offensive skill to a virtual object can cause damage to the virtual object, such as reducing a hit point or reducing movement speed. Releasing the auxiliary skill to the virtual object can add additional benefits to the virtual object, such as increasing a hit point or improving defense.

The second virtual wheel corresponding to the target skill is further displayed on the virtual scene interface. The target skill may be any skill that the first virtual object can release. The second virtual wheel corresponding to the target skill is configured to control an initial skill effect-taking location of the target skill. Second virtual wheels corresponding to different skills may be the same or different.

In a possible implementation, a process of displaying the second virtual wheel on the virtual scene interface includes: displaying the second virtual wheel on the virtual scene interface in response to a skill release operation on the target skill. In other words, the terminal does not display second virtual wheels respectively corresponding to skills on the virtual scene interface by default, but only displays a second virtual wheel corresponding to a specific skill when a player performs a skill release operation on the skill, so that the player controls an initial skill effect-taking location of the skill by controlling the second virtual wheel, facilitating improving of a display effect of the virtual scene interface.

In some examples, the terminal may alternatively display the second virtual wheel corresponding to the target skill on the virtual scene interface directly, without being limited by a release operation on the target skill.

202: The terminal selects, in response to a first movement operation on the second virtual wheel, a skill effect-taking location based on a movement direction of the first movement operation, and controls the first virtual object to release the target skill to the currently selected skill effect-taking location at an end of the first movement operation, the target skill having effect-taking duration.

The second virtual wheel is configured to control the initial skill effect-taking location of the target skill.

The second virtual wheel corresponding to the target skill is further displayed on the virtual scene interface. If a user wants to control the first virtual object to release the target skill, the user performs the first movement operation on the second virtual wheel, and keep the first movement operation to move on the second virtual wheel. Because the second virtual wheel is configured to control the initial skill effect-taking location of the target skill, the initial skill effect-taking location can be flexibly selected by performing the first movement operation. When determining that a current aimed location is an expected skill effect-taking location, the user ends the first movement operation, and the terminal controls the first virtual object to release the target skill at the skill effect-taking location.

The first movement operation is a movement operation generated through the second virtual wheel. A type of the first movement operation is not limited in examples of this application, provided that there is a clear movement direction. For example, the first movement operation may be an operation of moving based on a first press operation, may be an operation of moving based on a first touch operation, or the like.

The target skill in examples of this application has the effect-taking duration, for example, the effect-taking duration is 10 seconds or 15 seconds. The user does not need to perform another operation within the effect-taking duration, and the target skill continues taking effect. For example, if the target skill is to launch a virtual projectile, the first virtual object launches the virtual projectile automatically and continuously within the effect-taking duration.

203: The terminal adjusts, in response to a second movement operation on the first virtual wheel, the skill effect-taking location of the target skill based on a movement direction of the second movement operation within the effect-taking duration of the target skill, and controls the first virtual object to follow an adjusted skill effect-taking location to release the target skill.

If the user wants to adjust the skill effect-taking location within the effect-taking duration of the target skill, the user performs the second movement operation on the first virtual wheel, and keep the second movement operation to move on the first virtual wheel. The terminal adjusts the skill effect-taking location of the target skill based on the movement direction of the second movement operation. For example, when the movement direction of the second movement operation is eastward, a current skill effect-taking location is adjusted eastward. In a process of adjusting the skill effect-taking location, the first virtual object is controlled to follow the adjusted skill effect-taking location to release the target skill. In other words, a location where the skill effect-taking is adjusted to is a location where the target skill is released.

The second movement operation is a movement operation generated through the first virtual wheel. A type of the second movement operation is not limited in examples of this application, provided that there is a clear movement direction. For example, the second movement operation may be an operation of moving based on a second press operation, may be an operation of moving based on a second touch operation, or the like.

According to the method provided in examples of this application, a player may control a second virtual wheel to select an initial skill effect-taking location and release a skill at the effect-taking location. Within effect-taking duration of the skill, the player may further control a first virtual wheel to continue to adjust the skill effect-taking location, without a need of performing an operation of releasing the skill again. In addition, because the first virtual wheel is originally used to control a movement direction of a virtual object, the player is familiar with the first virtual wheel. During a skill effect-taking period, the first virtual wheel is used to adjust the effect-taking location, to enable the operation of the player to be smooth, reduce operating burden of the player, and improve convenience of adjusting the skill effect-taking location, thereby improving human-computer interaction efficiency of controlling a virtual object.

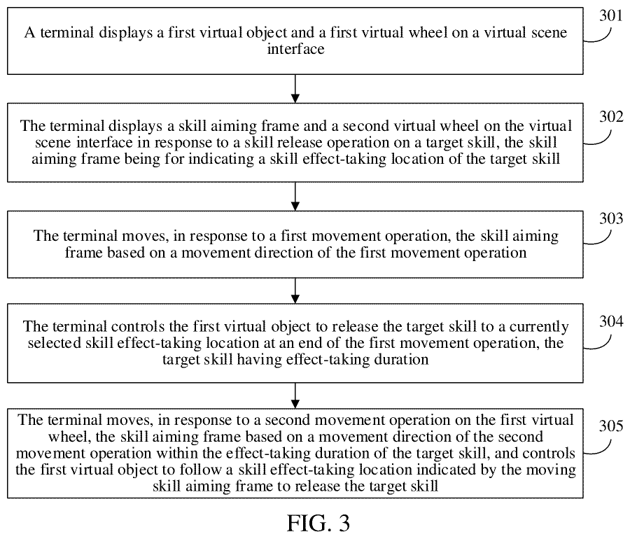

The example corresponding to FIG. 2 is a brief description of the virtual object control method provided in this application. The following describes the technical solution in this example of this application in detail. FIG. 3 is a flowchart of a virtual object control method according to an example of this application. This example of this application is performed by a terminal. Refer to FIG. 3. The method includes the following operations.

301: The terminal displays a first virtual object and a first virtual wheel on a virtual scene interface.

In some examples, the first virtual wheel is configured to control a movement direction of the first virtual object in a case that the first virtual object does not release any skill.

In a possible implementation, a skill control corresponding to at least one skill of the first virtual object is further displayed on the virtual scene interface. The skill control is configured to release a skill. For example, if the first virtual object currently has three skills, the terminal displays skill controls corresponding to these three skills on the virtual scene interface.

302: The terminal displays a skill aiming frame and a second virtual wheel on the virtual scene interface in response to a skill release operation on a target skill. The skill aiming frame is for indicating a skill effect-taking location of the target skill.

If a player wants to control the first virtual object to release the target skill, the player performs the skill release operation on the target skill. The terminal displays a skill aiming frame and a second virtual wheel corresponding to the target skill on the virtual scene interface in response to the skill release operation. For example, the skill release operation on the target skill may be a trigger operation (for example, a press operation) by a skill control corresponding to the target skill, or may be a shortcut operation for releasing the target skill.

In this example of this application, considering that a virtual object may have use permissions of a plurality of skills, if second virtual wheels corresponding to skills are displayed on the virtual scene interface simultaneously, a lot of content is displayed on the virtual scene interface, resulting in a poor displayed picture effect, and easily affecting an operation of the player. Therefore, the terminal might not display the second virtual wheels respectively corresponding to the skills on the virtual scene interface, but only displays a second virtual wheel corresponding to a skill when the player performs a skill release operation on the skill, so that the player controls an initial skill effect-taking location of the skill by controlling the second virtual wheel, facilitating improving of a display effect of the virtual scene interface.

In a possible implementation, the skill control corresponding to the target skill is further displayed on the virtual scene interface. The player performs a trigger operation (such as a press operation) on the skill control. In response to the trigger operation (such as the press operation) on the skill control, the terminal displays the second virtual wheel in an area at which the skill control is located, and displays the skill aiming frame on the virtual scene interface. After performing the press operation, the player continues to hold the press operation. After the terminal displays the second virtual wheel, the player controls the press operation to move on the second virtual wheel to select an initial skill effect-taking location of the target skill. This process is described in detail in the following operation 303.

In a possible implementation, because the skill aiming frame is for indicating the skill effect-taking location of the target skill, the skill aiming frame displayed by the terminal in response to the skill release operation indicates an initial skill effect-taking location automatically determined by the terminal. In this case, the terminal displays the skill aiming frame on the virtual scene interface in response to the skill release operation on the target skill, including any one of the following (1) to (3).

(1) The terminal displays the skill aiming frame at a location of a second virtual object in response to the skill release operation on the target skill in a case that the target skill is an offensive skill. The second virtual object is a virtual object closest to the first virtual object among virtual objects belonging to a different faction from the first virtual object.

The target skill causes damage to a virtual object at the skill effect-taking location in a case that the target skill is an offensive skill. Therefore, the target skill is used on an enemy virtual object. To be specific, when controlling the first virtual object to release the target skill, the player prefers that the skill effect-taking location of the target skill is a location of the enemy virtual object. Therefore, in response to the skill release operation on the target skill, the terminal determines the location of the second virtual object closest to the first virtual object and belonging to a different faction from the first virtual object as the initial skill effect-taking location of the target skill, so that the terminal displays the skill aiming frame at the location of the second virtual object.

In this example of this application, considering that the player prefers that the skill effect-taking location of the target skill is the location of the enemy virtual object in a case that the target skill is an offensive skill, the terminal automatically determines a location of a nearest enemy virtual object as the initial skill effect-taking location, so that the player does not need to manually adjust the initial skill effect-taking location to the location of the enemy virtual object, reducing operating burden of the player, thereby facilitating improving of skill release efficiency.

(2) The terminal displays the skill aiming frame at a location of a third virtual object in response to the skill release operation on the target skill in a case that the target skill is an auxiliary skill. The third virtual object is a virtual object closest to the first virtual object among virtual objects belonging to the same faction as the first virtual object.

The target skill adds additional benefits to the virtual object at the skill effect-taking location in a case that the target skill is an auxiliary skill. Therefore, the target skill is used on a friend virtual object. To be specific, when controlling the first virtual object to release the target skill, the player further prefers that the skill effect-taking location of the target skill is a location of the friend virtual object. Therefore, in response to the skill release operation on the target skill, the terminal determines the location of the third virtual object closest to the first virtual object and belonging to the same faction as the first virtual object as the initial skill effect-taking location of the target skill, so that the terminal displays the skill aiming frame at the location of the third virtual object.

In this example of this application, considering that the player prefers that the skill effect-taking location of the target skill is the location of the friend virtual object in a case that the target skill is an auxiliary skill, the terminal automatically determines a location of a nearest friend virtual object as the initial skill effect-taking location, so that the player does not need to manually adjust the initial skill effect-taking location to the location of the friend virtual object, reducing operating burden of the player, thereby facilitating improving of skill release efficiency.

(3) The terminal displays the skill aiming frame at a location of the first virtual object in response to the skill release operation on the target skill.

In this example of this application, considering that the player usually expects that a skill released by the first virtual object takes effect at a location of another virtual object near the current first virtual object, the terminal automatically determines the location of the first virtual object as the initial skill effect-taking location. Then, the player may adjust the initial skill effect-taking location to an expected location by performing a few operations, reducing operating burden of the player, thereby improving human-computer interaction efficiency and skill release efficiency.

303: The terminal moves, in response to a first movement operation, the skill aiming frame based on a movement direction of the first movement operation.

For example, the first movement operation may be an operation of moving based on a first press operation. The terminal may display, in response to movement of the first press operation on the second virtual wheel, the skill aiming frame to move based on a movement direction of the first press operation. A location of the skill aiming frame is the initial skill effect-taking location of the target skill. If the current skill effect-taking location is not the location expected by the player, the player may continue to keep the first movement operation and control the first movement operation to move on the second virtual wheel. The terminal adjusts the location of the skill aiming frame based on the movement direction of the first movement operation, so that the skill aiming frame moves based on the movement direction of the first movement operation. For example, when the movement direction of the first movement operation is eastward, the skill aiming frame also moves eastward.

Because the target skill is not released yet in a process of moving the skill aiming frame based on the movement direction of the first movement operation, a release special effect of the target skill is not displayed on an interface of moving the skill aiming frame based on the movement direction of the first movement operation.

In a possible implementation, in the foregoing operation 302, the terminal displays an area indication frame on the virtual scene interface in response to the skill release operation on the target skill. The area indication frame is for indicating an effective area of the target skill. In the operation 303, the terminal moves, in response to the first movement operation, the skill aiming frame in the area indication frame based on the movement direction of the first movement operation. For example, the first movement operation may be an operation of moving based on a first press operation. The terminal displays, in response to the movement of the first press operation on the second virtual wheel, the skill aiming frame to move in the area indication frame based on the movement direction of the first press operation.

In some examples, the effective area of the target skill is a circular area with the first virtual object as a center and a preset target value as a radius. The target value may be set based on experience, or may be flexibly adjusted based on a level of the first virtual object, a type of the target skill, and the like. For example, the target skill is to launch a virtual projectile, and the target value is a shooting range of the virtual projectile.

In some examples, the effective area of the target skill is a rectangular area with the first virtual object as a center, a first value as a width, and a second value as a length. The first value and the second value may be set based on experience, or may be flexibly adjusted based on the level of the first virtual object, the type of the target skill, and the like. The first value may be the same as or may be different from the second value.

The effective area of the target skill is only an exemplary description, which is not limited in examples of this application. For example, the effective area of the target skill may alternatively be a fan-shaped area.

An area on the virtual scene interface other than the effective area is an ineffective area of the target skill, and the location of the skill aiming frame is the skill effect-taking location. Therefore, the skill aiming frame can only be moved within the area indication frame and cannot be moved out of the area indication frame.

In some examples, the terminal keeps, after the skill aiming frame moves to an edge of the area indication frame, the location of the skill aiming frame unchanged in a case that the movement direction of the first movement operation indicates moving outside the area indication frame. When the skill aiming frame has moved to the edge of the area indication frame and the movement direction of the first movement operation still indicates moving outside the area indication frame, if the skill aiming frame is controlled to move in the movement direction of the first movement operation, the skill aiming frame moves out of the area indication frame. In this case, the terminal keeps the location of the skill aiming frame unchanged. The effective area of the target skill is set to avoid releasing of the target skill in the ineffective area, so as to improve standardization of a release range of the target skill, and further improve control standardization of a virtual object.

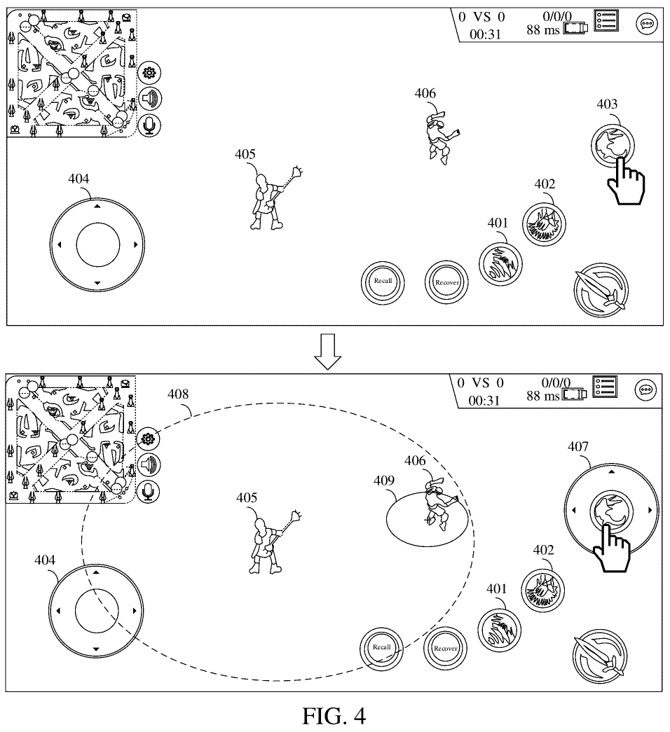

FIG. 4 is a schematic diagram of a virtual scene interface according to an example of this application. As shown in FIG. 4, a first skill control 401, a second skill control 402, a third skill control 403, a first virtual wheel 404, a first virtual object 405, and a second virtual object 406 are displayed on the virtual scene interface. When a player wants to control the first virtual object 405 to release a skill corresponding to the third skill control 403, the player performs a press operation on the third skill control 403. In this case, the terminal displays a second virtual wheel 407 in an area at which the third skill control 403 is located, and displays an area indication frame 408 and a skill aiming frame 409 on the virtual scene interface. The terminal displays the skill aiming frame 409 at a location of the second virtual object 406 in a case that the skill corresponding to the third skill control 403 is an offensive skill. The second virtual object 406 is a virtual object closest to the first virtual object 405 among the virtual objects belonging to a different faction from the first virtual object 405. During this period, the player may control a first press operation to move on the second virtual wheel 407 to adjust a location of the skill aiming frame 409 to select an initial skill effect-taking location of the skill.

304: The terminal controls the first virtual object to release the target skill to the currently selected skill effect-taking location at an end of the first movement operation. The target skill has effect-taking duration.

When determining that a current aimed location is an expected skill effect-taking location, the user ends the first movement operation, and the terminal controls the first virtual object to release the target skill at the currently selected skill effect-taking location.

In a possible implementation, the terminal adjusts a view angle of the virtual scene interface at the end of the first movement operation, to enable the skill aiming frame to be displayed in a central area of the virtual scene interface at the end of the first movement operation, and controls the first virtual object to release the target skill to the skill effect-taking location indicated by the skill aiming frame.

After the player ends the first movement operation, the view angle of the virtual scene interface is adjusted, so that the skill aiming frame is displayed in the central area of the virtual scene interface. In other words, the location of the skill aiming frame is moved to the central area of the virtual scene interface, to enable a skill release process to be clearly fed back to the player, to further assist the player in timely observing dynamics and whereabouts of a virtual object at the skill effect-taking location, facilitating subsequent adjustment of the skill effect-taking location.

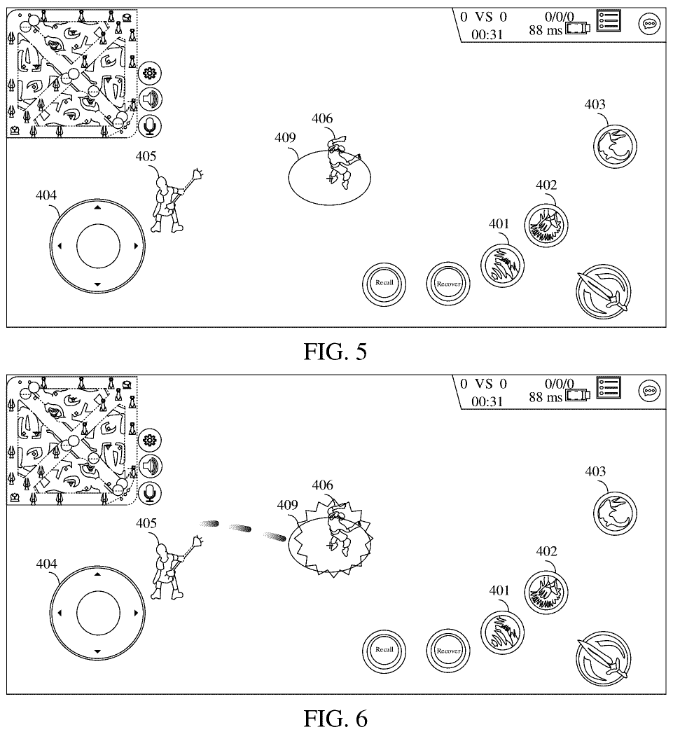

FIG. 5 is a schematic diagram of another virtual scene interface according to an example of this application. After the player ends the first press operation on the second virtual wheel 407 in FIG. 4, the virtual scene interface is as shown in FIG. 5. The terminal cancels a display of the second virtual wheel 407, and the skill aiming frame 409 is displayed in a central area of the virtual scene interface. As shown in FIG. 6, after adjusting the view angle of the virtual scene interface, so that the skill aiming frame is displayed in the central area of the virtual scene interface, the terminal displays a special effect of the first virtual object 405 releasing a skill to the location of the skill aiming frame 409, and duration of the special effect is effect-taking duration of the skill.

305: The terminal moves, in response to a second movement operation on the first virtual wheel, the skill aiming frame based on a movement direction of the second movement operation within the effect-taking duration of the target skill, and controls the first virtual object to follow a skill effect-taking location indicated by the moving skill aiming frame to release the target skill.

The location of the skill aiming frame is the initial skill effect-taking location of the target skill. If the user wants to adjust the skill effect-taking location within the effect-taking duration of the target skill, the user performs the second movement operation on the first virtual wheel, and keep the second movement operation to move on the first virtual wheel. The terminal adjusts the location of the skill aiming frame based on the movement direction of the second movement operation, and controls the first virtual object to release the target skill to the location of the skill aiming frame in real time. For example, when the movement direction of the second movement operation is eastward, the skill aiming frame moves eastward.

For example, if the player wants to apply the target skill to the second virtual object, and within the effect-taking duration of the target skill, if the second virtual object moves out of the skill effect-taking location, the player may manipulate the first virtual wheel to readjust the skill effect-taking location, to achieve locking the target skill on the second virtual object.

Because the target skill has been released in a process of moving the skill aiming frame based on the movement direction of the second movement operation, on an interface of the skill aiming frame moving based on the movement direction of the second movement operation, the first virtual object is controlled to follow the skill effect-taking location indicated by the moving skill aiming frame to release the target skill. In other words, a release special effect of the target skill is displayed in real time at the skill effect-taking location indicated by the skill aiming frame.

In examples of this application, the first virtual wheel has two functions. The first virtual wheel is configured to control a movement direction of the first virtual object in a case that the first virtual object does not release any skill; and the first virtual wheel is configured to adjust a skill effect-taking location of a skill in a case that the first virtual object is releasing the skill. Considering that in a case that a virtual object does not release a skill, focus of an operation of the player is to control movement of the virtual object, a function of the first virtual wheel in this case is to control the movement direction of the virtual object. Considering that in a case that the virtual object releases a skill, focus of the operation of the player is to adjust a skill effect-taking location of the skill, the function of the first virtual wheel in this case is to adjust the skill effect-taking location of the skill. Therefore, the player only needs to learn an operation method of the first virtual wheel to realize two different functions, thereby reducing operating burden of the player. In addition, because during a game, most of time the player needs to use the first virtual wheel to control the movement of the virtual object, the player is familiar with the first virtual wheel. During a skill effect-taking period, the first virtual wheel is used to adjust the effect-taking location, to facilitate improving of operating feel of the player.

In a possible implementation, the first virtual wheel and the second virtual wheel are displayed on different sides of the virtual scene interface. For example, the first virtual wheel and the second virtual wheel are respectively displayed on two sides (such as a left side and a right side or an upper side and a lower side) of the virtual scene interface. During a game, the player may trigger the second virtual wheel with one hand, and trigger the first virtual wheel with the other hand, avoiding a cumbersome situation of switching two different virtual wheels with the same hand, thereby improving operation simplicity. In addition, because during the game, most of time the player needs to use the first virtual wheel to control the movement of the virtual object, most of time one hand of the player is ready to press the first virtual wheel. Therefore, after releasing the skill, the player may quickly press the first virtual wheel to adjust the skill effect-taking location, further improving operation simplicity.

In a possible implementation, the terminal adjusts the view angle of the virtual scene interface in the process of moving the skill aiming frame based on the movement direction of the second movement operation, to enable the skill aiming frame to be displayed in the central area of the virtual scene interface.

In a process of the player adjusting the location of the skill aiming frame by pressing the first virtual wheel, the view angle of the virtual scene interface is adjusted in real time, so that the skill aiming frame is displayed in the central area of the virtual scene interface. In other words, the location of the skill aiming frame is moved to the central area of the virtual scene interface, to enable a skill release process to be clearly fed back to the player, which is equivalent to the view angle of the virtual scene interface also moving with movement of the skill aiming frame, to assist the player in timely observing dynamics and whereabouts of a virtual object at the skill effect-taking location, facilitating subsequent adjustment of the skill effect-taking location.

In a possible implementation, the terminal keeps, within the effect-taking duration of the target skill, the location of the first virtual object unchanged in response to the second movement operation on the first virtual wheel, rotates an orientation of the first virtual object to the skill effect-taking location indicated by the movement direction of the second movement operation, and controls the first virtual object to release the target skill to the skill effect-taking location indicated by the movement direction of the second movement operation.

Because in a process of the first virtual object releasing the skill, the first virtual wheel is configured to adjust the skill effect-taking location and is no longer configured to control the movement direction of the first virtual object, within the effect-taking duration of the target skill, even if the second movement operation moves on the first virtual wheel, the location of the first virtual object is kept unchanged. In addition, to present an effect of the first virtual object releasing the target skill to the skill effect-taking location, in a process of moving the skill effect-taking location, the direction of the first virtual object is rotated to a direction of the skill effect-taking location in real time, to improve authenticity of interaction with the first virtual object.

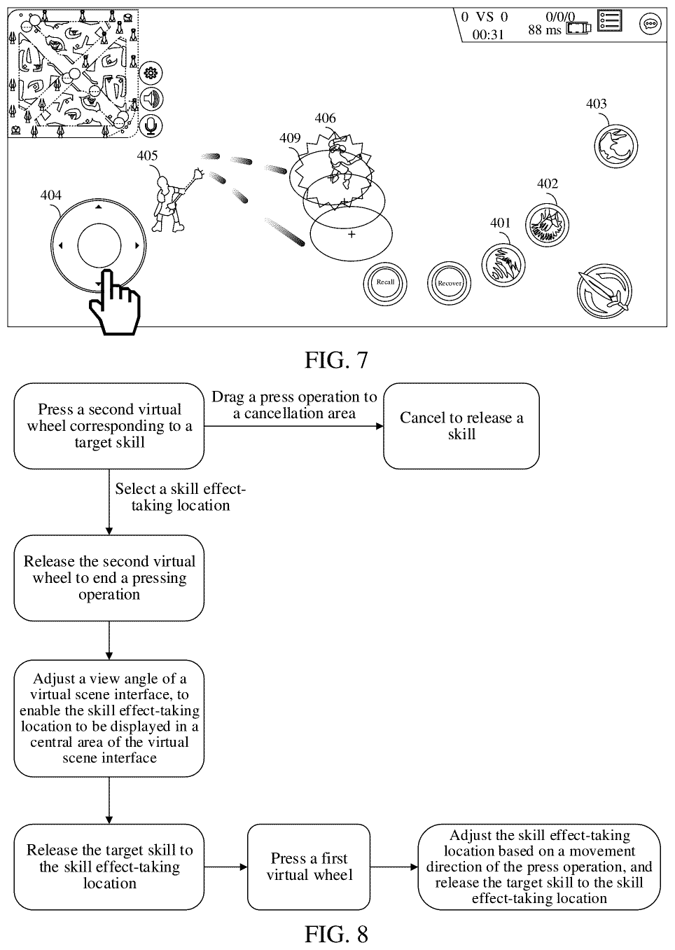

FIG. 7 is a schematic diagram of another virtual scene interface according to an example of this application. When a second virtual object 406 moves to a bottom of the virtual scene interface, the player moves a second press operation on a first virtual wheel 404 downward. In this case, a skill aiming frame 409 also moves to the bottom of the virtual scene interface. A movement trajectory of the skill aiming frame 409 is shown in FIG. 7. FIG. 7 is only to show the movement trajectory of the skill aiming frame 409. In actual application, a plurality of skill aiming frames do not display on the virtual scene interface simultaneously.

In a possible implementation, within effect-taking duration of a target skill, in a case that duration of a fourth virtual object being located at a skill effect-taking location indicated by the skill aiming frame reaches target duration, the terminal moves the skill aiming frame based on a movement direction of the fourth virtual object. In other words, the terminal displays the skill aiming frame to move based on the movement direction of the fourth virtual object, to enable the skill aiming frame to be located at a location of the fourth virtual object. The target duration is less than the effect-taking duration of the target skill. The fourth virtual object is any virtual object. For example, the fourth virtual object may be the first virtual object itself, or may be a second virtual object, a third virtual object, or the like.

In this example of this application, it is considered that if the duration of the fourth virtual object being located at the skill effect-taking location indicated by the skill aiming frame reaches the target duration, within the skill effect-taking duration, the player has been adjusting the skill effect-taking location to the location of the fourth virtual object. In other words, the player expects the target skill to take effect on the fourth virtual object. In this case, the terminal automatically locks the skill aiming frame at the location of the fourth virtual object, so that the fourth virtual object is always located at the skill effect-taking location of the target skill within the skill effect-taking duration. The player does not need to continue to manually manipulate the first virtual wheel to adjust the skill effect-taking location, further improving skill release efficiency and reducing operating burden of the player.

According to the method provided in examples of this application, a player may control a second virtual wheel to select an initial skill effect-taking location and release a skill at the effect-taking location. Within effect-taking duration of the skill, the player may further control a first virtual wheel to continue to adjust the skill effect-taking location, without a need of performing an operation of releasing the skill again. In addition, because the first virtual wheel is originally used to control a movement direction of a virtual object, the player is familiar with the first virtual wheel. During a skill effect-taking period, the first virtual wheel is used to adjust the effect-taking location, to enable the operation of the player to be smooth, and improve convenience of adjusting the skill effect-taking location, thereby improving human-computer interaction efficiency of controlling a virtual object.

Further, the second virtual wheel corresponding to a target skill is displayed when the player performs a skill release operation on the target skill, so that the player controls an initial skill effect-taking location of the target skill by controlling the second virtual wheel, facilitating improving of a display effect of the virtual scene interface.

In a case that the target skill is an offensive skill, the terminal automatically determines a location of a nearest enemy virtual object as the initial skill effect-taking location, so that the player does not need to manually adjust the initial skill effect-taking location to the location of the enemy virtual object, reducing operating burden of the player, thereby facilitating improving of skill release efficiency. The terminal automatically determines a location of a nearest friend virtual object as the initial skill effect-taking location in a case that the target skill is an auxiliary skill, so that the player does not need to manually adjust the initial skill effect-taking location to the location of the friend virtual object, reducing operating burden of the player, thereby facilitating improving of skill release efficiency. Considering that the player usually expects that a skill released by the first virtual object takes effect at a location of another virtual object near the current first virtual object, the terminal automatically determines the location of the first virtual object as the initial skill effect-taking location. Then, the player may adjust the initial skill effect-taking location to an expected location by performing a few operations, reducing operating burden of the player, thereby improving human-computer interaction efficiency and skill release efficiency.

The effective area of the target skill is set to avoid releasing of the target skill in the ineffective area, so as to improve standardization of a release range of the target skill, and further improve control standardization of a virtual object.

The view angle of the virtual scene interface is adjusted in real time, so that the location of the skill aiming frame is displayed in the central area of the virtual scene interface, to enable a skill release process to be clearly fed back to the player, which is equivalent to the view angle of the virtual scene interface also moving with movement of the skill aiming frame, to assist the player in timely observing dynamics and whereabouts of a virtual object at the skill effect-taking location, facilitating subsequent adjustment of the skill effect-taking location.

In a process of moving the skill effect-taking location, the direction of the first virtual object is rotated to a direction of the skill effect-taking location in real time, to improve authenticity of interaction with the first virtual object.

The first virtual wheel and the second virtual wheel are displayed on two sides of the virtual scene interface. During a game, the player may trigger the second virtual wheel with one hand, and trigger the first virtual wheel with the other hand, avoiding a cumbersome situation of switching two different virtual wheels with the same hand, thereby improving operation simplicity. In addition, because during the game, most of time the player needs to use the first virtual wheel to control the movement of the virtual object, most of time one hand of the player is ready to press the first virtual wheel. Therefore, after releasing the skill, the player may quickly press the first virtual wheel to adjust the skill effect-taking location, further improving operation simplicity.

In a case that the duration of the fourth virtual object being located at the skill effect-taking location indicated by the skill aiming frame reaches the target duration, the terminal automatically locks the skill aiming frame at the location of the fourth virtual object, so that the fourth virtual object is always located at the skill effect-taking location of the target skill within the skill effect-taking duration. The player does not need to continue to manually manipulate the first virtual wheel to adjust the skill effect-taking location, further improving skill release efficiency and reducing operating burden of the player, thereby improving human-computer interaction efficiency.

In related art, when controlling a virtual object to release a skill, the player may select a skill effect-taking location only when performing a skill release operation. After selecting the skill effect-taking location, the player releases the skill to the skill effect-taking location. During a skill release period, the player cannot readjust the skill effect-taking location unless the skill release operation is re-initiated and the skill effect-taking location is reselected. Therefore, if the player wants to change the skill effect-taking location, the player needs to perform the skill release operation a plurality of times, such as pressing a corresponding skill control a plurality of times. In a case that a virtual object has a plurality of skills, operating burden of the player is great and an operation is not simple enough.

An example of this application provides a virtual object control solution. According to the solution, a skill effect-taking location of a skill can be conveniently adjusted. As shown in FIG. 8, the method includes the following operations (1) to (6).

(1) A player presses a second virtual wheel corresponding to a target skill. In addition, if the player wants to cancel to release the skill, the player drags a press operation to a cancellation area and then release the press operation. When the terminal detects that the press operation is dragged to the cancellation area and ends, the skill is canceled to release.

(2) The player controls the press operation to move on the second virtual wheel to select a skill effect-taking location, and then releases the second virtual wheel to end the press operation.

(3) The terminal adjusts a view angle of a virtual scene interface, to enable the skill effect-taking location to be displayed in a central area of the virtual scene interface.

(4) The terminal controls a virtual object to release the target skill to the skill effect-taking location.

(5) The player presses a first virtual wheel and controls the press operation to move on the first virtual wheel to adjust the skill effect-taking location.

(6) The terminal adjusts the skill effect-taking location based on a movement direction of the press operation, and releases the target skill to the skill effect-taking location.

In examples of this application, according to a solution to control two virtual wheels simultaneously, in which the second virtual wheel is used to determine an initial skill effect-taking location, and the first virtual wheel is used to adjust the skill effect-taking location, operating burden the player is reduced, a skill release feel of the player is improved, thereby providing new skill release experience for the player. In addition, in a case that a virtual object has a plurality of skills, the first virtual wheel may be configured to adjust skill effect-taking locations of all skills, which is equivalent to the first virtual wheel providing a plurality of uses, further reducing operating pressure of the player.

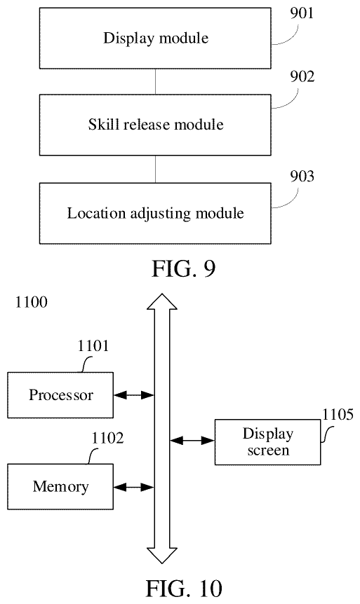

FIG. 9 is a schematic diagram of a structure of a virtual object control apparatus according to an example of this application. Refer to FIG. 9. The apparatus includes:
a display module 901, configured to display, on a virtual scene interface, a first virtual object, a first virtual wheel, and a second virtual wheel corresponding to a target skill, the first virtual wheel being configured to control a movement direction of the first virtual object in a case that the first virtual object does not release any skill;
a skill release module 902, configured to select, in response to a first movement operation on the second virtual wheel, a skill effect-taking location based on a movement direction of the first movement operation, and control the first virtual object to release the target skill to the currently selected skill effect-taking location at an end of the first movement operation, the target skill having effect-taking duration; and
a location adjusting module 903, configured to adjust, in response to a second movement operation on the first virtual wheel, the skill effect-taking location of the target skill based on a movement direction of the second movement operation within the effect-taking duration of the target skill, and control the first virtual object to follow an adjusted skill effect-taking location to release the target skill.

According to the virtual object control apparatus provided in examples of this application, a player may control a second virtual wheel to select an initial skill effect-taking location and release a skill at the effect-taking location. Within effect-taking duration of the skill, the player may further control a first virtual wheel to continue to adjust the skill effect-taking location, and does not need to perform an operation of releasing the skill again. In addition, because the first virtual wheel is originally used to control a movement direction of a virtual object, the player is familiar with the first virtual wheel. During a skill effect-taking period, the first virtual wheel is used to adjust the effect-taking location, to enable the operation of the player to be smooth, and improve convenience of adjusting the skill effect-taking location, thereby improving human-computer interaction efficiency of controlling a virtual object.

In some examples, the location adjusting module 903 is configured to:
move, in response to the second movement operation on the first virtual wheel, a skill aiming frame based on the movement direction of the second movement operation within the effect-taking duration of the target skill, the skill aiming frame being for indicating the skill effect-taking location of the target skill.

In some examples, the location adjusting module 903 is further configured to:
adjust a view angle of the virtual scene interface in a process of moving the skill aiming frame based on the movement direction of the second movement operation, to enable the skill aiming frame to be displayed in a central area of the virtual scene interface.

In some examples, the location adjusting module 903 is further configured to:
keep a location of the first virtual object unchanged, and rotate an orientation of the first virtual object to a skill effect-taking location indicated by the movement direction of the second movement operation.

In some examples, the display module 901 is configured to display a skill aiming frame and the second virtual wheel on the virtual scene interface in response to a skill release operation on the target skill, the skill aiming frame being for indicating the skill effect-taking location of the target skill; and
the skill release module 902 is configured to move the skill aiming frame based on the movement direction of the first movement operation in response to the first movement operation.

In some examples, the display module 901 is configured to implement any one of the following:
displaying the skill aiming frame at a location of a second virtual object in response to the skill release operation on the target skill in a case that the target skill is an offensive skill, the second virtual object being a virtual object closest to the first virtual object among virtual objects belonging to a different faction from the first virtual object;
displaying the skill aiming frame at a location of a third virtual object in response to the skill release operation on the target skill in a case that the target skill is an auxiliary skill, the third virtual object being a virtual object closest to the first virtual object among virtual objects belonging to a same faction as the first virtual object; and
displaying the skill aiming frame at the location of the first virtual object in response to the skill release operation on the target skill.

In some examples, the display module 901 is further configured to:
display an area indication frame on the virtual scene interface in response to the skill release operation on the target skill, the area indication frame being for indicating an effective area of the target skill; and move the skill aiming frame in the area indication frame based on the movement direction of the first movement operation in response to the first movement operation.

In some examples, the display module 901 is further configured to:
keep, after the skill aiming frame moves to an edge of the area indication frame, a location of the skill aiming frame unchanged in a case that the movement direction of the first movement operation indicates moving outside the area indication frame.

In some examples, the skill release module 902 is configured to:
adjust a view angle of the virtual scene interface at the end of the first movement operation, to enable the skill aiming frame to be displayed in a central area of the virtual scene interface at the end of the first movement operation; and
control the first virtual object to release the target skill to the skill effect-taking location indicated by the skill aiming frame.

In some examples, the first virtual wheel and the second virtual wheel are displayed on different sides of the virtual scene interface.

In some examples, the location adjusting module 903 is further configured to:
move, in response to duration of a fourth virtual object being located at the skill effect-taking location indicated by the skill aiming frame reaching target duration, the skill aiming frame based on a movement direction of the fourth virtual object within the effect-taking duration of the target skill, the target duration being less than the effect-taking duration, and the fourth virtual object being any virtual object.

Division of the functional modules of the virtual object control apparatus provided in the foregoing examples is merely described as an example. In actual application, the foregoing functions may be assigned according to needs to be implemented by different functional modules, that is, an internal structure of the terminal is divided into different functional modules, so as to implement all or a part of the functions described above. In addition, the virtual object control apparatus provided in the foregoing examples and the virtual object control method examples fall within the same concept. Refer to method examples for details about the specific implementation process. Details are not described herein again.

An example of this application further provides a terminal. The terminal includes a processor and a memory, the memory has at least one computer program stored therein, and the at least one computer program is loaded and executed by the processor to enable the terminal to implement operations performed according to the virtual object control method according to the foregoing examples.

FIG. 10 is a schematic diagram of a structure of a terminal 1100 according to an exemplary example of this application.

The terminal 1100 includes: a processor 1101 and a memory 1102.

The processor 1101 may include one or more processing cores, for example, a 4-core processor or an 8-core processor. The processor 1101 may be implemented in at least one hardware form of digital signal processing (DSP), a field programmable gate array (FPGA), or a programmable logic array (PLA). The processor 1101 may alternatively include a main processor and a coprocessor. The main processor is a processor configured to process data in an awake state, and is also referred to as a central processing unit (CPU). The coprocessor is a low-power-consumption processor configured to process data in a standby state. In some examples, the processor 1101 may be integrated with a graphics processing unit (GPU). The GPU is configured to render and draw content that needs to be displayed on a display screen. In some examples, the processor 1101 may further include an artificial intelligence (AI) processor. The AI processor is configured to process computing operations related to machine learning.

The memory 1102 may include one or more computer-readable storage media. The computer-readable storage medium may be non-transient. The memory 1102 may further include a high-speed random access memory and a nonvolatile memory, for example, one or more disk storage devices or flash storage devices. In some examples, the non-transient computer-readable storage medium in the memory 1102 is configured to store at least one computer program. The at least one computer program is used by the processor 1101 to enable the terminal 1100 to implement the virtual object control method according to the method examples of this application.

In some examples, the terminal 1100 may alternatively include: a display screen 1105.

The display screen 1105 is configured to display a user interface (UI). The UI may include a graph, text, an icon, a video, and any combination thereof. When the display screen 1105 is a touch display screen, the display screen 1105 also has a capability to collect a touch signal on or above a surface of the display screen 1105. The touch signal may be inputted to the processor 1101 as a control signal for processing. In this case, the display screen 1105 may be further configured to provide a virtual button and/or a virtual keyboard, which is also referred to as a soft button and/or a soft keyboard. In some examples, there may be one display screen 1105 disposed on a front panel of the terminal 1100. In some other examples, there may be at least two display screens 1105 disposed on different surfaces of the terminal 1100 respectively or in a folded design. In some other examples, the display screen 1105 may be a flexible display screen disposed on a curved surface or a folded surface of the terminal 1100. Even, the display screen 1105 may be further set in a non-rectangular irregular pattern, namely, a special-shaped screen. The display screen 1105 may be prepared by using materials such as a liquid crystal display (LCD) or an organic light-emitting diode (OLED). For example, a first virtual object, a first virtual wheel, a second virtual wheel, and the like are displayed by using the display screen 1105.

A person skilled in the art may understand that the structure shown in FIG. 10 constitutes no limitation on the terminal 1100, and the terminal 1100 may include more or fewer components than those shown in the figure, or some components may be combined, or different component deployments may be used.

An example of this application further provides a non-volatile computer-readable storage medium. The non-volatile computer-readable storage medium has at least one computer program stored thereon, and the at least one computer program is loaded and executed by a processor to enable a computer to implement operations performed according to the virtual object control method according to the foregoing examples.

An example of this application provides a computer program product, including a computer program. The computer program is loaded and executed by a processor to enable a computer to implement operations performed according to the virtual object control method according to the foregoing examples.

A person of ordinary skill in the art may understand that all or some of the operations of the foregoing examples may be implemented by hardware, or may be implemented by a program instructing relevant hardware. The program may be stored on a non-volatile computer-readable storage medium. The storage medium may be a read-only memory, a magnetic disk, an optical disc, or the like.

The foregoing descriptions are merely exemplary examples of examples of this application, and are not intended to limit examples of this application. Any modification, equivalent replacement, or improvement made within the principle of examples of this application fall within the protection scope of this application.

What is claimed is:

1. A virtual object control method comprising:
displaying, on a virtual scene interface, a first virtual object, a first virtual wheel, and a second virtual wheel corresponding to a target skill, the first virtual wheel being configured to control a movement direction of the first virtual object;
selecting, in response to a first operation on the second virtual wheel, a skill effect-taking location based on a movement direction of the first operation;
controlling the first virtual object to release the target skill to the selected skill effect-taking location based on the first operation, the target skill having an effect-taking duration;
adjusting, by a computing device, in response to a second operation on the first virtual wheel, the skill effect-taking location of the target skill based on a movement direction of the second operation within the effect-taking duration of the target skill; and
controlling the first virtual object to follow the adjusted skill effect-taking location to release the target skill.

2. The virtual object control method according to claim 1, wherein the adjusting comprises:
moving, in response to the second operation on the first virtual wheel, a skill aiming frame based on the movement direction of the second operation within the effect-taking duration of the target skill, and wherein the skill aiming frame indicates the skill effect-taking location of the target skill.

3. The virtual object control method according to claim 2, further comprising:
adjusting a view angle of the virtual scene interface in a process of moving the skill aiming frame based on the movement direction of the second operation, to enable the skill aiming frame to be displayed in a central area of the virtual scene interface.

4. The virtual object control method according to claim 1, further comprising:
keeping a location of the first virtual object unchanged, and rotating an orientation of the first virtual object to a skill effect-taking location indicated by the movement direction of the second operation.

5. The virtual object control method according to claim 1, wherein the displaying the second virtual wheel comprises:
displaying a skill aiming frame and the second virtual wheel on the virtual scene interface in response to a skill release operation on the target skill, wherein the skill aiming frame indicates the skill effect-taking location of the target skill; and
wherein the selecting comprises:
moving, in response to the first operation, the skill aiming frame based on the movement direction of the first operation.

6. The virtual object control method according to claim 5, wherein the displaying the skill aiming frame comprises one of:
displaying the skill aiming frame at a location of a second virtual object in response to the skill release operation on the target skill in a case that the target skill is an offensive skill, the second virtual object being a virtual object closest to the first virtual object among virtual objects belonging to a different faction from the first virtual object;
displaying the skill aiming frame at a location of a third virtual object in response to the skill release operation on the target skill in a case that the target skill is an auxiliary skill, the third virtual object being a virtual object closest to the first virtual object among virtual objects belonging to a same faction as the first virtual object; or
displaying the skill aiming frame at the location of the first virtual object in response to the skill release operation on the target skill.

7. The virtual object control method according to claim 5, further comprising:
displaying an area indication frame on the virtual scene interface in response to the skill release operation on the target skill, wherein the area indication frame indicates an effective area of the target skill; and
the moving the skill aiming frame based on the movement direction of the first operation in response to the first operation comprising:
moving the skill aiming frame in the area indication frame based on the movement direction of the first operation in response to the first operation.

8. The virtual object control method according to claim 7, further comprising:
keeping, after the skill aiming frame moves to an edge of the area indication frame, a location of the skill aiming frame unchanged in a case that the movement direction of the first operation indicates moving outside the area indication frame.

9. The virtual object control method according to claim 5, wherein the controlling the first virtual object to release the target skill to the selected skill effect-taking location comprises:
adjusting a view angle of the virtual scene interface at an end of the first operation, to enable the skill aiming frame to be displayed in a central area of the virtual scene interface at the end of the first operation; and
controlling the first virtual object to release the target skill to the skill effect-taking location indicated by the skill aiming frame.

10. The virtual object control method according to claim 2, further comprising:
moving, in response to a duration of a fourth virtual object being located at the skill effect-taking location indicated by the skill aiming frame reaching a target duration, the skill aiming frame based on a movement direction of the fourth virtual object within the effect-taking duration of the target skill, the target duration being less than the effect-taking duration.

11. A virtual object control apparatus, comprising:
one or more processors; and
memory storing instructions that, when executed by the one or more processors, cause the virtual object control apparatus to:
display, on a virtual scene interface, a first virtual object, a first virtual wheel, and a second virtual wheel corresponding to a target skill, the first virtual wheel being configured to control a movement direction of the first virtual object;
select, in response to a first operation on the second virtual wheel, a skill effect-taking location based on a movement direction of the first operation, and control the first virtual object to release the target skill to the selected skill effect-taking location based on the first operation, the target skill having effect-taking duration;
adjust, in response to a second operation on the first virtual wheel, the skill effect-taking location of the target skill based on a movement direction of the second operation within the effect-taking duration of the target skill; and
control the first virtual object to follow the adjusted skill effect-taking location to release the target skill.

12. The virtual object control apparatus according to claim 11, wherein the instructions, when executed by the one or more processors, cause the virtual object control apparatus to adjust by moving, in response to the second operation on the first virtual wheel, a skill aiming frame based on the movement direction of the second operation within the effect-taking duration of the target skill, and wherein the skill aiming frame indicates the skill effect-taking location of the target skill.

13. The virtual object control apparatus according to claim 12, wherein the instructions, when executed by the one or more processors, cause the virtual object control apparatus to: adjust a view angle of the virtual scene interface in a process of moving the skill aiming frame based on the movement direction of the second operation, to enable the skill aiming frame to be displayed in a central area of the virtual scene interface.

14. The virtual object control apparatus according to claim 11, wherein the instructions, when executed by the one or more processors, cause the virtual object control apparatus to:
keep a location of the first virtual object unchanged, and rotate an orientation of the first virtual object to a skill effect-taking location indicated by the movement direction of the second operation.

15. The virtual object control apparatus according to claim 11, wherein the instructions, when executed by the one or more processors, cause the virtual object control apparatus to: display a skill aiming frame and the second virtual wheel on the virtual scene interface in response to a skill release operation on the target skill, wherein the skill aiming frame indicates the skill effect-taking location of the target skill; and
move the skill aiming frame based on the movement direction of the first operation in response to the first operation.

16. The virtual object control apparatus according to claim 15, wherein the instructions, when executed by the one or more processors, cause the virtual object control apparatus to:
display the skill aiming frame by displaying the skill aiming frame at a location of a second virtual object in response to the skill release operation on the target skill in a case that the target skill is an offensive skill, the second virtual object being a virtual object closest to the first virtual object among virtual objects belonging to a different faction from the first virtual object;
display the skill aiming frame at a location of a third virtual object in response to the skill release operation on the target skill in a case that the target skill is an auxiliary skill, the third virtual object being a virtual object closest to the first virtual object among virtual objects belonging to a same faction as the first virtual object; or
display the skill aiming frame at the location of the first virtual object in response to the skill release operation on the target skill.

17. The virtual object control apparatus according to claim 15, wherein the instructions, when executed by the one or more processors, cause the virtual object control apparatus to:
display an area indication frame on the virtual scene interface in response to the skill release operation on the target skill, wherein the area indication frame indicates an effective area of the target skill; and
move the skill aiming frame in the area indication frame based on the movement direction of the first movement operation in response to the first movement operation.

18. The virtual object control apparatus according to claim 17, wherein the instructions, when executed by the one or more processors, cause the virtual object control apparatus to keep, after the skill aiming frame moves to an edge of the area indication frame, a location of the skill aiming frame unchanged in a case that the movement direction of the first movement operation indicates moving outside the area indication frame.

19. The virtual object control apparatus according to claim 15, instructions, when executed by the one or more processors, cause the virtual object control apparatus to control the first virtual object to release the target skill by:
adjusting a view angle of the virtual scene interface at an end of the first operation, to enable the skill aiming frame to be displayed in a central area of the virtual scene interface at the end of the first operation; and
controlling the first virtual object to release the target skill to the skill effect-taking location indicated by the skill aiming frame.

20. A non-transitory computer-readable storage medium, when executed, cause:
displaying, on a virtual scene interface, a first virtual object, a first virtual wheel, and a second virtual wheel corresponding to a target skill, the first virtual wheel being configured to control a movement direction of the first virtual object;
selecting, in response to a first operation on the second virtual wheel, a skill effect-taking location based on a movement direction of the first operation;
controlling the first virtual object to release the target skill to the selected skill effect-taking location based on the first operation, the target skill having an effect-taking duration;
adjusting, in response to a second operation on the first virtual wheel, the skill effect-taking location of the target skill based on a movement direction of the second operation within the effect-taking duration of the target skill; and
controlling the first virtual object to follow the adjusted skill effect-taking location to release the target skill.
